(19) United States
(12) Patent Application Publication
(10) Pub. No.: US 2012/0150509 A1
(43) Pub. Date: Jun. 14, 2012

(54) Continuous optimization energy reduction process in commercial buildings

(76) Inventor: Patrick Andrew Shiel, Dublin (IE)

(21) Appl. No.: 13/374,128

(22) Filed: Dec. 13, 2011

Related U.S. Application Data
(60) Provisional application No. 61/459,504, filed on Dec. 14, 2010.

(51) Int. Cl. G06F 17/50

(52) U.S. Cl. 703/2; 703/6

(57) ABSTRACT

The invention provides a method and system for optimizing energy usage (where “energy” means electric, gas, and other energy sources) in commercial buildings. In one embodiment of the invention, historical energy consumption data is used, along with occupant data, to determine appropriate adjustments in energy usage. The invention further provides for ongoing monitoring and reporting of energy savings.

A system according to the invention implements a process which consists of six stages of analysis: Usage/Energy Use Mapping and data collection, Occupant Comfort Analysis (aka Energy Zoning), Load Matching/Plant scheduling, Occupant Comfort Data Collection/Building Characterization, Design Iterative Building Energy Strategies and Energy Usage/Savings Reports/Detailed Advice Reports.

### RELATED INVENTIONS

This application is related to and claims priority from U.S. provisional application 61/459,504, of the same title and by the same inventor filed Dec. 14, 2010, the entirety of which is incorporated by reference as if fully set forth herein.

### FIELD OF USE

The invention is useful in energy management, and more particularly in the field of energy management in commercial buildings.

### BACKGROUND

The design and commissioning of commercial buildings is a long process involving many different fields of expertise. When the level of occupant comfort in the building has been decided upon and the Heating, Ventilation and Air Conditioning (HVAC) plant has been installed and commissioned, the building is normally deemed ready for use. The level of occupant comfort is normally calculated by a series of look up tables for various levels of occupant numbers, humidity, external temperature and so on. There is a growing belief amongst the research community that the focus of comfort should be the occupant rather than simply heating or cooling the building.

Energy use in commercial buildings has been served for many years, by a number of software simulation tools which seek to predict the comfort levels of buildings while estimating the energy use. The underlying principles of these tools concentrate on the building itself and the desire to keep that building at a particular level of warmth and/or humidity.

Occupant comfort is assumed to be serviced based on generalized set of parameters and tables used by designers in specifying the building and plant within it. As a matter of common knowledge, such an approach is not very accurate when it comes to use of energy.

### BRIEF SUMMARY OF THE INVENTION

The invention provides a method and system for optimizing energy usage (where “energy” means electric, gas, and other energy sources) in commercial buildings. In one embodiment of the invention, historical energy consumption data is used, along with occupant data, to determine appropriate adjustments in energy. The invention further provides for ongoing monitoring and reporting of energy savings.

The invention provides a process which finds a way to use the least amount of energy to maintain desired occupant comfort levels. The process assumes the existing building will remain as is and the installed plant will not be changed. Therefore the reduction in energy use is solely because of changes to the way the building is operated rather than any upgrades to building or plant.

Starting with the utility bills, by measurement and analysis, the inventive method provides for precisely matching the operation of plant to the desired occupant comfort level thus eliminating avoidable waste of energy.

The inventive method provides a means to focus specifically on occupant comfort relative to the plant supplying those comfort levels within a known building. Next, by working back from the utility bills and matching the operation of plant to the desired occupant comfort level, avoidable energy waste may be eliminated.

### BRIEF DESCRIPTION OF THE DRAWINGS

The figure below are intended as an aide to understanding the invention:

FIG. 1 depicts the inventive method according to a preferred embodiment.

FIG. 2 schematic of the mechanical cooling and chilling system of Dundrum shopping mall in Dublin

FIG. 3 is a graph of Main Plant Transformer Benchmark 24 hour Load in a case study at Dundrum of FIG. 2

FIG. 4 is a graph of 24-Hour Fluctuation in Flow and Return Temperatures—Pump P5

FIG. 5 is a graph of 24-Hour Fluctuation in Flow and Return Temperatures—Condenser Water Local Sensor

FIG. 6 is a graph of Red Transformer Load with Variable Speed Drives Installed

FIG. 7 is a graph showing condenser water pump optimization according to the invention

FIG. 8 is a graph the final Red Transformer load as it is after the Chiller pumps have been included along with two of the primary condenser pumps

### DETAILED DESCRIPTION OF THE PREFERRED EMBODIMENT

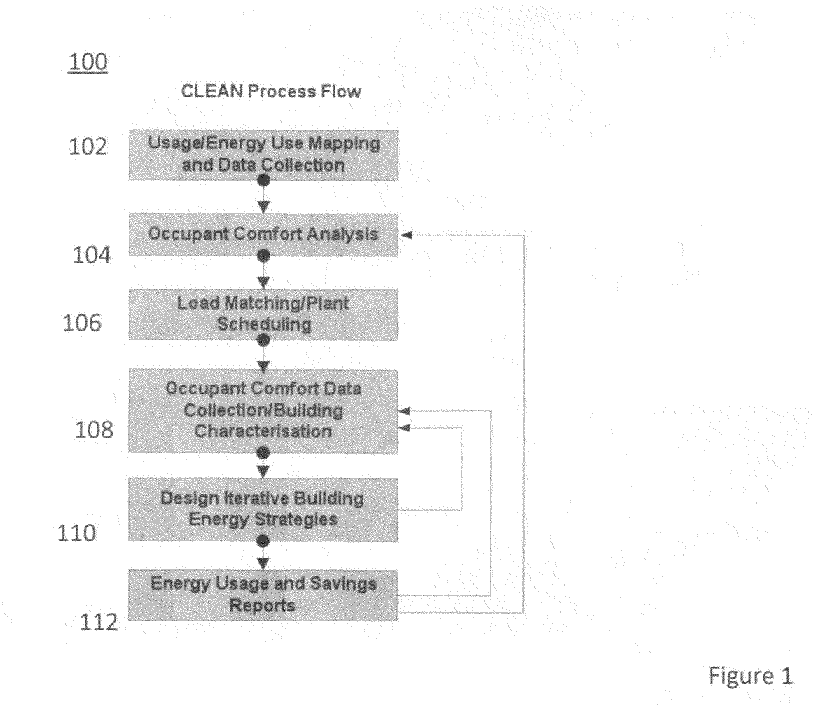

Briefly, the invention provides a method of eliminating energy waste in commercial buildings while maintaining occupant comfort. FIG. 1 depicts steps performed by a system operating according to the invention. For a building or plant under analysis, the method comprises the steps of:
a. Usage/energy use mapping and data collection 102
b. occupant comfort analysis 104
c. load matching/plant scheduling 106
d. occupant comfort data collection/building characterization 108
e. design iterative building energy strategies 110
f. energy usage reports and savings reports 112

By starting with the utility bills, by measurement and analysis, the invention provides for precision in matching the operation of plant supplying energy to building under analysis to the desired occupant comfort level in the building (or buildings) under analysis.

Once the data from the utility bills, plant schedules and operating hours of the building are analyzed, a series of tests are scheduled principally when the building is unoccupied, these tests being designed to show how the building responds to thermal inputs such as solar gain, computer equipment, lighting. From these tests including at least one when the building is occupied to show how the occupants affect the thermal response, the process will show how the building should perform when mechanical heating and cooling are applied. This response is verified with live tests. We can therefore assemble a simple building Energy Equation which tells us how the building responds to thermal inputs. For any given level of external temperature, this equation can be of the form

BE_{tc}=MH_{tc}+MC_{tc}+OH_{tc}+MV_{tc}+CEH+LH

where:

### BE_{tc}—Building Energy at Comfort Temperature tc (kW)

MH_{tc}—Mechanical Heating required to provide the comfort temperature tc (kW)
MC_{tc}—Mechanical cooling required to provide the comfort temperature tc (kW)
OH_{tc}—Occupant Heat output at the desired comfort temperature tc (kW)
MV_{tc}—Mechanical ventilation required at comfort temperature tc (kW)
CEH—Computer and office equipment heat output (kW)
LH—Lighting heat output (kW)

The purpose of this equation is to inform the building operator of the minimum amount of energy required to achieve occupant comfort levels for any set of external weather variables, particularly external temperature. Ultimately, the equation allows us to derive a building control strategy for the minimum use of energy to deliver required occupant comfort levels.

Commercial and academic research has been looking into ways to develop a generalised algorithm to predict energy use in buildings—both commercial and residential. The research has informed many designers about ways and methods to enhance the building and the way in which energy is used within. Most current methods rely on modelling techniques which use data compiled about the envelope of the building (so-called building physics), heating, cooling and ventilation plant along with generalised usage figures regarding personnel and their comfort needs. Armed with this data, the modelling technique will calculate a predicted energy use. These models have been found to produce numbers of varying accuracy and are mainly used before the construction work commences. Research on existing buildings has also produced a body of knowledge relating to predicted energy use based on various data collected directly from the building (temperatures, humidity, etc) coupled with external weather data. These efforts have produced various techniques to allow energy use prediction and are mainly used by the electricity generation and supply industry. We have seen some of these techniques in the patent search already undertaken.

The invention, sometimes referred to herein as Continuous Optimization, starts looking at the energy use of buildings from the other end and thus by working back, develops a model or energy equation unique to each building—automatically. This equation allows elimination of avoidable energy waste.

In an embodiment according to the invention, Continuous Optimization provides a six stage process which allows a reduction in energy by eliminating avoidable waste in any building. The collection of data from the building is not unique, nor is the reporting tool that follows the analysis. What is unique is the coupling of Occupant Comfort data and weather to the plant operating data to determine how the building responds—referred to as Building Characterization. The Characterization stage thus uses a very limited dataset and feeds this to the Design Iterative Building Energy Strategies Stage which determines minimised energy use. The invention enables the performing of energy use Building Characterization very quickly and very cheaply. This has many uses beyond the Continuous Optimization process.

The ‘normal’ way of looking at energy use in a building is to start with the building physics, in other words the thermal heat transfers occurring between zones (or rooms). These transfers can happen through walls, windows, heat loss/gain to/from the internal/external environment. Then examine the requirements of the personnel within and try to come up with energy use numbers and compare with the actual energy use. Rather than looking at the energy use by starting with the building itself, we start with the actual energy bills as the first point of truth. The second point of truth is the use and personnel requirements within the building and finally the third point of truth is the actual plant installed to heat/cool and ventilate the building. Continuous Optimization assumes these points of truth are fixed. By collecting specialized data related solely to occupant comfort, the process is thus able to characterise the building. Out of 154 relevant research papers reviewed over the past month, we have found no reference going back over 20 years to the concept of Building Characterization. Characterization allows the process to formulate an energy equation for the building. This equation will allow the process to optimize energy use and eliminate avoidable waste. The equation is continuously applied to the building and iteratively modified if necessary.

As commonly understood by engineers, “characterization” is a process whereby an entity is examined and the entity's operating and min/max limits are determined. Every electronic, electrical and mechanical device or piece of equipment cannot be offered for sale without such a characterisation process being performed upon it (e.g. HP Printers, HP Components, etc). However, “characterization” as a process is not currently performed on buildings for at least two reasons. Firstly, each building will have its own ‘character’ and the determination of this character is not normally funded by the building owner, and secondly, each building's character will change over time and according to use.

The invention provides a process which not only enables the building to be characterized, but also enables this characterization to be continuous. The characterization will determine how a building responds to external weather conditions, to its own plant, to changes in use, to personnel requirements, etc.

A substantial variety of data is normally available from a commercial building. It is normally used exclusively by the Building Management System (BMS) to control the heating/cooling and ventilation plant. The invention requires a very small subset of the data normally available form a commercial building. Moreover, the invention utilizes a sensor array which can be deployed in any building to send the required data to the system according to the invention.

The Continuous Optimization process has been developed in response to the very real need to facilitate non-engineering personnel understand and control energy costs in medium to large scale buildings. The invention identifies and eliminates avoidable energy waste by continuous re-commissioning of a building. This is achieved by accurately matching the actual building use by its occupants with the installed electrical and electro-mechanical plant. The very important novel idea is that building occupant activity and habits are overlaid on building plant thus optimizing the existing plant with the occupant needs. The process seeks to solve the energy reduction problem with existing plant in the first instance and only in the event of plant failure does the process recommend replacement or upgrade.

Historically building design has been the domain of architects coupled with several disciplines of engineering. The present system of design tends to produce over specification. Some have estimated this over specification to run as high as three or four times the required level of plant particularly in mechanical system such as air handlers and chilling plant. This has led to woefully inadequate attention being paid to energy efficiency in buildings. With a few notable exceptions, the newer the building, the worse is the energy efficiency. The invention addresses the existing building stock and is independent of the particular use of building, type of plant installed or the prevailing weather system in the region. The invention is particularly effective in solving energy inefficiencies where buildings not suited to the environment have been transposed onto the landscape, perhaps by an over-zealous designer.

The invention provides a repeatable and automatable system and process, and can be carried out by non-engineering personnel. The invention differs from other approaches focusing on building use and existing plant. Simply put, take the building as is with all its inherent problems and match that building to the occupants. If any upgrades are required, a sub-six month payback period is assumed. The other significant forward step when using the process is that the actual work required to achieve the savings is part of the process rather than some separate and independent body of work.

The modern commercial building has taken many evolutionary steps in arriving at its present form. Whether the building is office or retail, leisure or medical in nature, the same environmental issues must be solved and in general the solutions are put in place through extensive use of mechanical and electro-mechanical plant.

Over the past twenty years, the fabric of these commercial buildings has evolved into a highly insulated and air tight envelope. Indeed the methods used to heat and cool these buildings rely on this very air-tightness and with this many problems have been introduced including Sick-Building Syndrome. The air-tightness issue is a major problem in that the modelling of the air and heat flows within the building is predicated on a controlled environment. In other words the theory is, the more air-tight the building is—the more controllable the air and heat flows are. The reality is stuffy buildings where Indoor Air Quality (IAQ) is not carefully monitored.

The inventive Continuous Optimization process can be applied to improve IAQ along with lowering energy use by careful analysis of plant function and schedules. Too many times do we encounter air being extracted from an open space, being chilled to remove moisture and re-circulated through a heating element to occupant temperature—resulting in totally in-efficient use of energy.

For a typical commercial building project, anything up to seven or eight years can elapse between the original concept of the building being developed and the eventual occupation of the building by the initial tenants. There are three distinct phases in this process: design, construction and occupation. At each phase, changes may be introduced that will materially impact on the eventual performance of the building during occupation.

During the design phase, the building envelope and mechanical and electrical (M&E) systems are designed and redesigned through several iterations. While these iterations are recorded in the drawings and documents, normally and understandably, the M&E design is completed to allow maximum flexibility in the building's use. It is this very desire for flexibility which guarantees an over-designed building. To optimise the energy efficiency of buildings, a completely integrated design cycle process is required. However, the tools, processes and lack of experience in the design disciplines mean that this as a rule does not happen effectively.

After design has been completed, the build phase begins. Once again there are many possibilities for changes to be introduced during this process. For practical reasons onsite such as geophysics, material limitations, impractical routing of services, adherence to schedule, change of use decisions; alterations are made to the systems and controls that are installed in the building. While drawings exist to record these changes, there is generally no analysis of the impact that these changes will have on the energy efficiency of the building once complete.

When the building has been completed and the first tenants move in, it is not uncommon to take between one to two years of use before every system has been fully commissioned and is operating effectively. During this time, new products used for the first time may exhibit limitations or incompatibilities with other products. In addition, materials and actual usage may differ substantially from the design. As a result, the modifications that are made to the systems and controls are completely aimed at making the system operational rather than optimizing it in use. At this point it may be six to eight years after the building was first designed and there have been changes in the materials and technology used in constructing similar buildings. All too often Facilities Management (FM) companies say that their job is simply to ‘keep the building running.’

It can be concluded that the main issues with this process is that all of the engineering effort goes into the upfront design and build. Occupation and use of the building is assigned a level of engineering effort which is aimed at “maintaining” its condition. In order to achieve major levels of energy reduction, one must somehow be able to “re-engineer” the building given the constraints that (a) the building will remain occupied during this process and (b) that major (or even minor) physical renovations or upgrades will generally not be possible.

In order to re-engineer buildings a new process for re-commissioning buildings in use has been developed. This process focuses on achieving significant energy reductions in existing buildings. The process is repeatable which once installed is continuously run and updates usage databases and comprises a number of phases of activity which are explained in the subsequent sections. The invention, Continuous Optimization operates perfectly well if the building has a Building Management System (BMS) or not—it is independent of all building physics, actual installed plant and external weather patterns.

A preferred embodiment of the invention provides a process consisting of six independent stages of analysis:

Phase 1 Usage/Energy Use Mapping and data collection—mapping the building usage by physical or activity zone.
Phase 2 Occupant Comfort Analysis (aka Energy Zoning)—zoning of the thermal requirements of the building with regard to occupant comfort and regulatory requirements
Phase 3 Load Matching/Plant scheduling—matching of all electrical, gas and water loads to the thermal zones, fiscal utility bills and local tariffs. Determination of sub-metering requirements for all utility types.
Phase 4 Occupant Comfort Data Collection/Building Characterization—identification (and possible design) of data collection strategy from sub-meters, data loggers and Building Management Systems (BMS) on 15-30 minute intervals—implementation of this strategy
Phase 5 Design Iterative Building Energy Strategies—generation of full energy audit reports and full benchmark comparisons—cross referenced with local weather data. Invoicing on monthly energy savings also produced.
Phase 6 Energy Usage/Savings Reports/Detailed Advice Reports—generation of upgrade guide report indicating the likely areas of saving and improved efficiency.

The invention provides for generation and output of a very valuable set of data which allows a non-technical team to implement energy audits and significant energy savings. The invention in alternate embodiments further develops the data models to assign work tasks to the various members of the implementation team. This is done on a workflow basis, and may be accomplished by backing this data into an ERP system, to allow its use on a wider scale. A discussion of the six phases follows herein below.

Phase 1: Usage/Energy Use Mapping. Data Requirements are: detailed building plans; current layouts of offices, retail units, car parks, etc.—tenant numbers and footfall estimates; currently installed services and mapping of these services to the physical layout.

Usage mapping is a phase I activity which allows the building to be analysed as built versus current layouts. Changes may have occurred since occupancy and hence services may be over- or under-serving some areas. The activity allows for the identification of these discrepancies. All usable space in the building must be assigned a use and where this space is under 1% of the total buildings, it may be absorbed into an adjoining space. The usage mapping phase inputs: are: Building Plans. The usage mapping phase outputs are: Set of dimensioned areas assigned usage with space volume data; Electrical and mechanical plant associated with each of these areas (may be shared).

Phase 2: Energy Zoning. Data Requirements are: Resulting areas from Phase 1; Minimum regulatory comfort requirements including ASHRAE 55, CIBSE Guide A, ISO 7730 and EN 15251,; Weather pattern data (available from the local Met Office, for example).

Energy zoning is a process by which the building is divided into thermal zones. The final zoning of the building will likely differ from Phase I areas. These zones indicate what occupant comfort level must be delivered along with the minimum regulatory requirements. The operator or landlord will also have minimum service delivery parameters—these will vary depending on the building use. Each thermal zone is thus described by the occupant comfort parameters versus the minimum service delivery parameters. This activity will help yield the basis on which the minimum amount of energy usage can be calculated when average weather patterns are taken into account. The results are compared with the latest data available on energy use benchmarks available from a variety of local and international research units.

Phase 2 inputs are: Results from Phase I; Service delivery parameters after discussion with the Facilities Manager/Operator; phase 2 outputs are: Set of zones with calculated theoretical thermal loads dependent on weather data; Total or partial minimum energy requirements based on these thermal zones.

Phase 3 is load matching. Load Matching is a process by which the supply of electrical and mechanical services is analysed and the mechanism by which usage can be determined. This requires analysis of the way the electrical services have been laid out in the building and specifically how these electrical services supply electro-mechanical plant. The end-goal is to account for over 96% of all electrical use in the building. Normally gas and oil use are very simple to account for but electricity use requires a very different approach. The process will yield a theoretical electrical use value and a mechanism by which this can be permanently verified with a series of sub-meters and loggers. Analysis is also completed on the Energy Tariff regime currently in use within the building. The other available tariffs are also applied to the energy use pattern to give early indications of possible savings.

The data requirement for load matching are: Resulting minimum energy requirements from Phase 2; Electrical and Mechanical Services Plans; Fiscal energy bills; Energy Company tariff data. The inputs are: Discussion with Maintenance personnel regarding locations of meters and wiring of same; Physical scope and location of all on-site electrical/gas/oil/water meters. The outputs are: Full plan of sub-metering and logging to allow full measurement of energy use; Indicative savings based on tariff analysis alone. This allows the account manager to run billing models to predict likely savings based on this early data.

Phase 4, Occupant Comfort Data Collection/Building Characterization, is a vital part of the process as it gives the actual usage and shift in energy loads throughout the day and night. The physical identification of meters, loggers, etc. is completed and a plan for the sub-metering is implemented from the last phase. The installation of this sub-metering network is completed in this phase and should yield a complete and accurate picture of all energy use over a 24 hour period. The aim here is to make it possible to reconcile between actual energy used in what plant with the fiscal bills and the agreed tariffs to a 96% level. The sub-meters and loggers should be installed and set to log on a 15/30 minute basis and automatically transmit their data to Head Office each night in a secure and robust manner. It may also be required to auto-extract certain data from the BMS on a nightly basis also and this forms part of this process. The Building Characterization phase informs how the building responds to the various thermal inputs including mechanical heating, mechanical cooling, lighting, office equipment, solar gain and occupant heat output. These tests are performed in conjunction with knowledge of the local weather at that time.

Data requirements for phase 4 are: Resulting sub-metering schedule and plan from Phase 3; Electrical and Mechanical Services drawings; Building Network details and method for communicating with Head Office. Inputs are: Results from Phase 3; Physical scope and location of all on-site electrical/gas/oil/water meters. Outputs are: Ability to log all relevant energy use data remotely, correct any data discrepancies and load the data into a suitable relational database.

Phase 5, Design Iterative Building Energy Strategies/Data Analysis, represents the first time the actual energy loads are compared with our earlier phases of theoretical load work. This is an iterative process with changes in model parameters being edited automatically to allow the earlier phase models to more accurately represent what is actually going on in the building. There is sufficiently detailed data in the database at this point to allow the process to perform energy optimisation. This is achieved through an iterative process known as ‘Building Characterization’ and what this represents is a convergence of actual energy use data with the earlier estimated or modelled buildings based on building fabric and generalised use. The process will find energy use conflicts and eliminate them. It will also try to lower the use of equipment while analysing the effect on the occupant comfort space. The convergence mentioned above may take several weeks to achieve and is based on actual energy use. A number of very important outputs flow from this phase including Energy Audit Reports which are the usage reports produced for the client each month along with any number of other yokes.

The data requirements for phase 5 are: Resulting energy model data from Phases 2, 3 and 4; Fiscal energy bills; Energy Company tariff data. The inputs are the results from phase 2 though 4. The outputs are Actual energy usage figures and reports; Indicative and actual savings based on changes to plant, plant schedules and strategies; Monthly invoices.

Phase 6: Taking the database from phase 5, and the electrical and mechanical service plans, and in some cases feedback from facilities manager as to tenant effects with implemented changes, phase 6 provides that Detailed Advice Reports are produced every time a change is made on site regarding energy use and updated in the database. This can include any/all of the following changes: Tariff Structure or energy supplier; Any relevant plant upgrade or change; Any BMS Strategy Change; Any alteration to weather assumptions and subsequent change to plant schedules (non-BMS).

The output of phase 6 in a preferred embodiment of the invention are ongoing-detailed energy reports detailing changes and effects of changes on energy use and subsequent bills.

In summary, below is a list of data required by a preferred embodiment of the invention:
General model parameters of the building makeup—access to direct sunlight, e.g. glass roof, opening windows vs. sealed envelope, etc.
All electrical and electro-mechanical plant listed with power ratings
Accurate listing of all plant running times
Usage mapping of the entire building
Occupancy and use figures for the building over a one week period (typical)
Interval temperature and humidity data for all occupied areas of the building for one week (preferably one weeks data in each of the local seasons—because the invention provides for continuous optimization as a continuous process)
External temperature, humidity, rainfall, sunshine data

The invention according to a preferred embodiment is completely independent of building physics. The process does not attribute any level of analytical importance to the construction method, envelope types or materials used to ascertain optimum use of plant. The invention is unique in this feature as well as other features as described herein. The plant and building performance data collected for one week provide all the data needed regarding the building fabric.

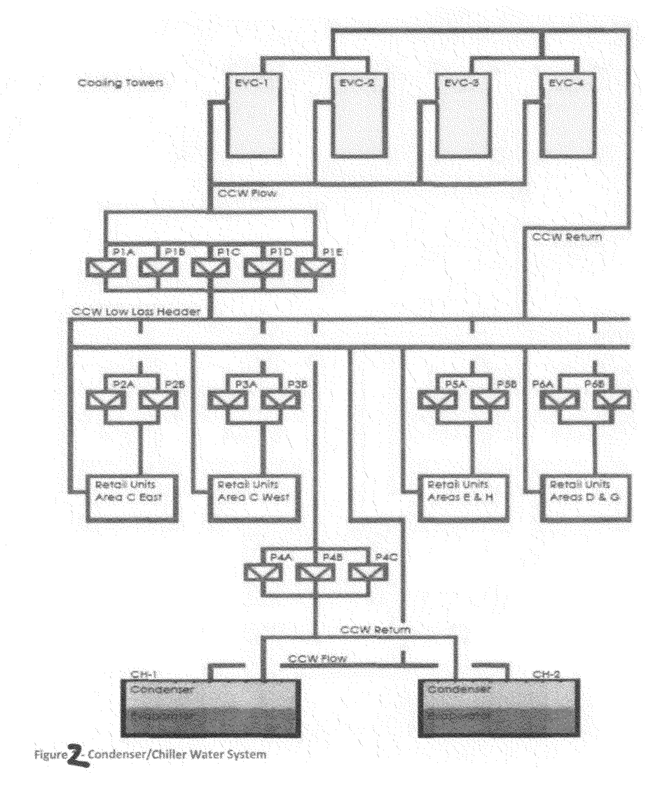

CASE STUDY—Dundrum Town Centre is located in South County Dublin in Ireland and currently occupies over 100,000 m² with a second phase planned, which will increase the centre to almost 150.000 m². The centre opened in 2005 and is one of Europe's largest Shopping Malls. The main building complex in the centre is cooled electrically via an evaporative cooling system backed up by dual 500 KW mechanical chiller units. The entire system is controlled by a Trend IQ3 series Building Management System (BMS) linked to a Trend 963 supervisor. Energy bills at the Centre in 2008 were in the region of ε1,3M and this was accounted for by cooling, lighting and auxiliary power, with the main contributor being the cooling. Four evaporative cooling towers operate on demand to provide cooling to a secondary condenser water supply used by the landlord and tenants to provide heat pumps for their local chillers. A schematic of the mechanical cooling and chilling system is shown in FIG. 2. EVC1-4 represents the cooling towers, P1A-E are the five primary condenser water pumps. P2A-B, P3A-B, P5A-B and P6A-B are the Duty/Standby pump pairs handle the secondary condenser water, while the P4A-C pumps are the primary chiller pumps. The two chillers are CH-1, CH-2.

Usage Mapping. The process of re-commissioning the centre began at Dundrum with the zoning of the building into physical usage areas. The main mall and other landlord areas were modelled into sub-zones and the services that fed these zones were established. In addition, each of the 120 retail units located at the centre was zoned separately to enable the modelling of services such as condenser water and potable mains water services.

The following usage zones were identified—
a. Landlord Mall or Front of House (FOH)
b. Closed Retail
c. Open Retail—retail space open to the Landlord Mall
d. Back of House (delivery and service areas)
e. Plant Rooms and maintenance areas
f. Office Space
   Each zone was calculated in terms of square metreage and volume. The building fabric was not taken into account as it is irrelevant within this process.

Energy Zoning. With the areas, volumes and uses identified occupant comfort levels were applied along with the necessary regulatory requirements (mainly from Parts L of the building regulations). This yielded a minimum set and an average set of comfort parameters which formed the basis of minimum energy use.

Load Matching. Starting with the fiscal utility bills for electricity, gas and water, the plant installed and servicing the above usage zones is identified and characterised. For commercial buildings, the utility bills are normally available in 30 minute time slices. In this form, the bills are particularly useful in identifying plant use over the 24-hour period. For Dundrum Town Centre, the electricity bill was available in this form and it helped to clearly identify the running of the plant in FIG. 1 over the 24-hour day. This was particularly relevant as the Dundrum tariffs vary from night-rate to day-rate and peak-rate.

The plant was also examined to determine what sub-metering was needed. This involves a detailed working knowledge both of physical plant and the wiring layout thereof. Where sub-metering is required to determine usage patterns, this was installed. Sub-metering involves the installation of a class I or class II electrical meter. These meters must be capable of handling up to 1,000 Amps of three phase power. Thirteen such meters of varying sizes were installed on site. This allows us to achieve two goals—first to monitor plant to accurately match loads with the fiscal bill and second to accurately prove savings after strategy changes are implemented.

The Internal Air Quality (IAQ) of a particular space is determined by various measurements involving CO₂, temperature and humidity. In the case of Dundrum, only temperature is accurately monitored and recorded. We deemed this to be insufficient and having carefully examined the likely air flows through the landlord's areas of the buildings, we installed a temporary CO₂ and humidity sensor in a number of worst case locations. This data was recorded by the system along with all the sub-metering points. This upgrading of IAQ sensors ensured we could monitor and control the air quality while lowering plant usage in a later stage of the process.

Data Collection. For a period of one month, extended data logging was performed on the building and a number of the larger pieces of plant were electrically sub-metered to establish their power consumption. Once this data had been assembled, it was automatically analyzed and normalized against degree days and occupancy to establish base loads for plant and also to identify anomalies in energy consumption. The latter are typically where avoidable waste is discovered. A detailed business requirements list was made for each zone, reviewing the current opening hours, and the actual demand for services and levels of comfort and lighting. Finally the entire dataset was benchmarked against known good practice for this type of building within the Dublin weather patterns. Plant that had been installed since the control systems had originally been designed was also documented to track any impact they would have on any possible changes.

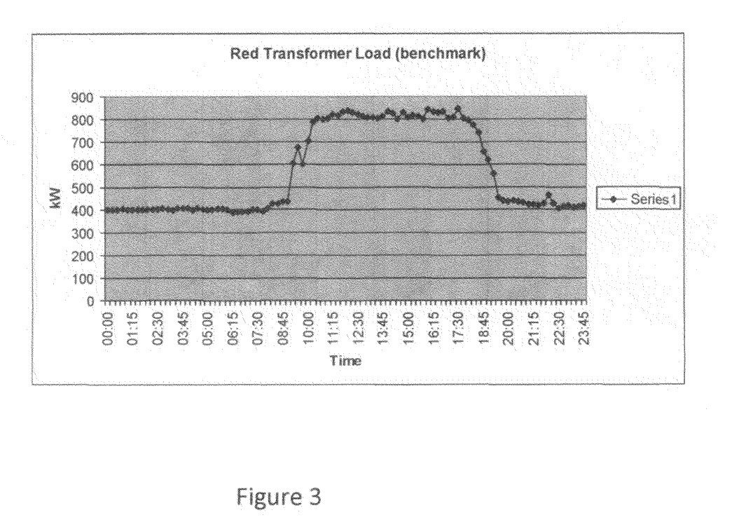

Re-Design of Building Plant Strategies. The analysis of the very large amount of overall data drew attention four potential sub-projects each of which were identified as likely to result in significant savings. It must also be understood that all four systems mentioned interact with each other in a very real way—
a. Condenser Secondary Water System
b. Condenser Water Primary System
c. Chiller Water System and Air Handling Units
d. Lighting System
   The first three projects involve plant powered from one single transformer thus making it possible to more easily ascertain savings results from any change to BMS schedules or BMS strategies. The graph in FIG. 3 shows the 24 hour load on this transformer before any intervention. The Lighting System project on the other hand involves up to 32 lighting panels dispersed all over the mall.

FIG. 3—Main Plant Transformer Benchmark 24 hour Load. It is clear from the graph in FIG. 3 that the bulk of the plant in the Centre has a daytime load of over 800 kW and a night-time load of approximately 400 kW. There are several obvious ‘shoulders’ in the graph which can be traced back to equipment coming on in ‘pre-charge’ mode.

Condenser Secondary Water System—This system provides a mechanism for all tenants to dump excess heat from the Air-Con units installed in their respective units. The Condenser Secondary gets water to and from the tenants while the Condenser Primary gets this heated water to the Cooling towers for evaporative Cooling. Design changes were made which have created a mismatch between the original requirements and the current requirements.

There are four main index circuits in the building and a log of the temperature in each of these was taken. This log showed that the load on the systems both during the day and at night showed opportunities for achieving significant savings. The graph below shows the fluctuation in flow and return temperatures in the main index circuit pump. It can be seen from this graph that the main period of load is between 9am and 9pm and that outside of these hours, the demand for cooling drops to a lower level. Examination of the other three pumps showed similar patterns.

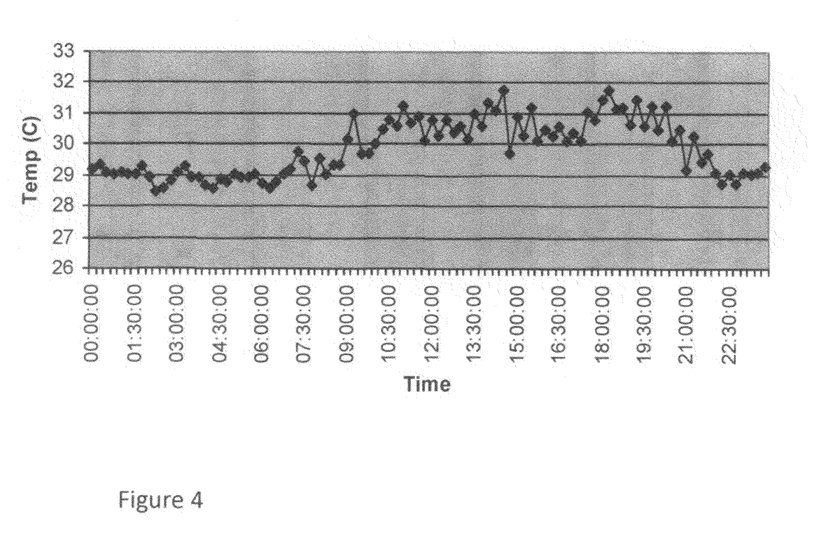

FIG. 4—24-Hour Fluctuation in Flow and Return Temperatures—Pump P5 (typical). Further study was made of the system and it was established that the profile of cooling requirement at night was based on the specific loads that were operating overnight. Certain equipment was operating 24 hours a day and this needed to be maintained. Temperature was recorded for a number of these overnight consumers and it was established that these locations were dumping a high rate of heat even during the night, as shown in FIG. 4. In comparison with FIG. 3, it can be seen that this local pattern is invisible in the overall trend of the main index circuit. The placement of these sensors has been therefore shown to be critical when using their data to affect BMS control. It was expected that this would place constraints on the possibilities for deriving savings from operation of these pumps. The same pattern occurred to differing degrees in the other three pumps.

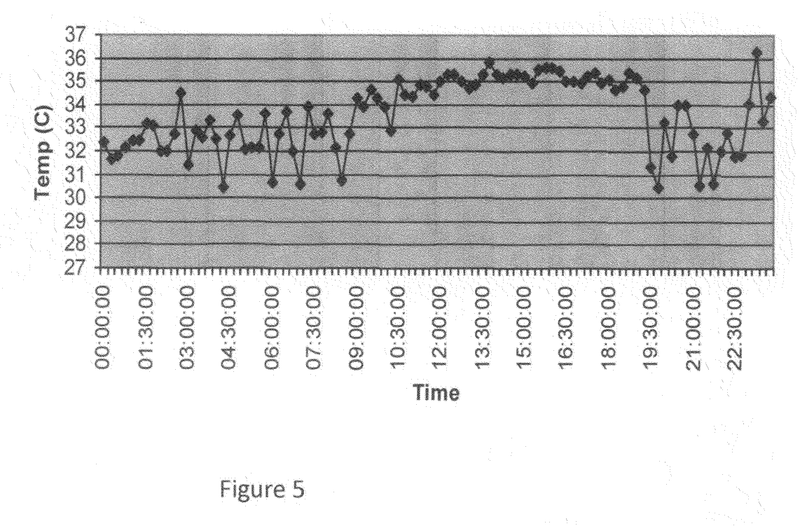

FIG. 5—24-Hour Fluctuation in Flow and Return Temperatures—Condenser Water Local Sensor. The requirements were clearly a combination of both the explicit i.e. they could easily be identified by the centre operators and the tenants and the implicit i.e. constraints and other requirements that were there as a result of the systems already in place. Taking these into account, a re-design was made of the way in which the pumps would be controlled using Variable Speed Drives (VSD) under BMS control. It was clear that the strategy for BMS control would be different for each of the pumps and also different during the day and at night. A flexible strategy was designed to allow this control to be fine tuned over a period of time in order to maximize the savings achieved while at the same time delivering the levels of comfort and service committed to by the operator.

The combined power consumption of the four pumps was over 160 kW, giving a daily rate of 3,852 kWh. The new BMS strategy was designed and written to match the speed of the drives (frequency) to specific temperature sensors. The sensors used are in different locations during the day and at night time to enable the system to cater for the different load profiles. The system was initially operated at conservative (high) flow rates for a week to ensure that all of the control mechanisms were operating correctly and furthermore that the duty rotation mechanism was also operating correctly. The limits of the control system were then separately optimized for day and night time use.

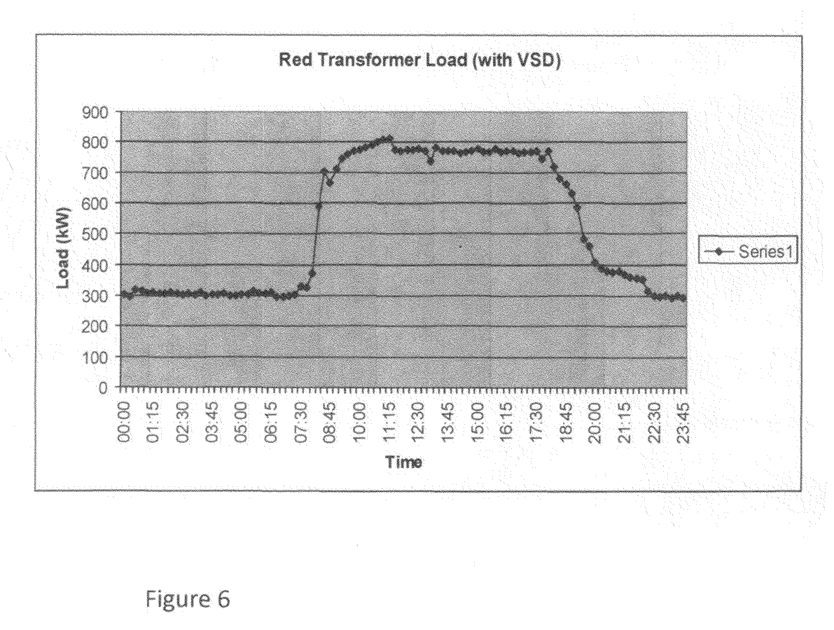

FIG. 6—Red Transformer Load with Variable Speed Drives Installed. The graph shows a marked reduction in overnight load of 100 kW and an average daytime reduction of 38 kW.

Condenser Water Primary System—this gets Condenser water to and from the Evaporative Cooling Towers and provides the main mechanism to dump Condenser water heat. The Cooling Towers comprise four dual towers each section of which is under BMS control. Sections are brought on during the day by the BMS as required in response to a rising water temperature in the main Condenser Water Index circuit. At night, only one of these towers is normally running with the lower heat load from the tenants. The Condenser Primary system comprises five pumps with a combined power load of 150 kW. With the lowering of the Condenser Secondary pumps overnight, the Condenser Primary pumps could also be lowered to match the system flows.

Chiller Water System and Air Handling Units—this system gets chilled water to and from the Air-Handling Units (AHU) to provide an additive mechanism to cool air entering the mall. At design time, the chilled water system was intended to boost the cooling process on very warm days but in practice, the chillers were running almost flat out even on days where un-cooled fresh air should have been used by the AHUs. The Condenser Water was also fed directly to the chiller primary coils as a means of dumping the chiller heat. This condenser water circuit is fed by three pumps and was left running even when the Chillers were disabled at night. The result of this was to inadvertently transfer heat from the Condenser side to the chiller side and thus raise the Chilled Water Circuit temperature from its' normal 12° C. to a 32-35° C. range during the night. This presented the chiller with a very substantial job of work to lower water temperature each morning. Chiller breakdown was a very regular occurrence but happily now is no longer an issue as a consequence of the inventive method.

The AHUs are mixed mode operation which allows the units operate in either fresh air or in re-circulation mode which normally requires additive cooling (provided by the Chilled Water). These air streams can be mixed and this process is under BMS control. The AHUs also have a heating section when outside air temperature is too low. There is a very well understood control mechanism which relies on Return Air Temp, External Air Temp, Internal Air Quality (IAQ) and Supply Air Temp to control these units. However, the commissioning process and the subsequent use of the units were throwing up some very unusual usage and BMS control data indicating these well understood mechanisms were not implemented here. The units were found to be operating in an unpredictable manner which made the re-commissioning task very interesting. One bank of four AHUs was found to be relying on an External Air Temp sensor which went out of control range during long periods of sunshine. This made the AHUs enter re-circulation mode which rejects fresh air in favour of used mall air which needs to be cooled with Chilled Water. Corrections were made to the control strategy.

Lighting System—The Dundrum Centre has a combined lighting load of over 420 kW. This represents a very substantial portion of the overall Centre load. The lighting system has been wired though 32 separate electrical panels of varying loads. The emergency or essential systems are intertwined with non-essential lighting and as such, make the control of individual circuits very difficult if not impossible without some re-wiring. The BMS has between four and 16 control points in each of these panels. After analysing four of the largest panels, it was decided to go ahead with sub-metering and rewiring of these four panels. The process by which this analysis was completed was to map the circuits to actual lighting loads (identifying essential and non-essential loads) and finally map these circuits to BMS Control points while identifying the least disruptive mechanism of re-wiring. The estimated savings are between 23% and 45% depending on the panel.

Validation of the New System. While we have presented our results below as four independent sub-projects, it must be remembered that all four systems (especially the first three) are heavily dependent on each other but in the interest of clarity and ease of explanation, they are summarised as independent.

Condenser Secondary Water—The savings during the day amount to a reduction to less than 98 kW, which is a reduction of almost 33%. At night time, the savings were fine tuned by gradually altering the limits in the BMS and observing and logging the impact this had on flow rates and local temperatures. The results of this fine tuning can be seen in FIG. 4. During this fine tuning process, the combined power output of the pumps was reduced without negatively impacting on service to just over 50 kW, which is a reduction of almost 66% over the original power output.

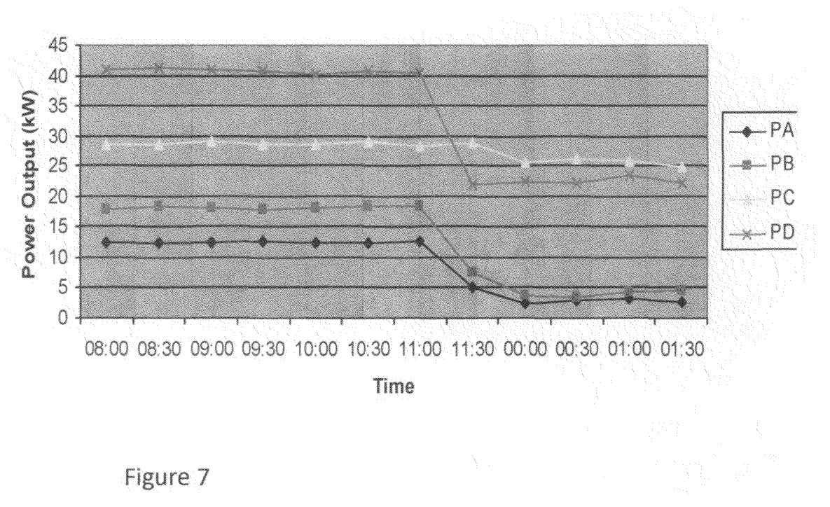

FIG. 7 Condenser Water Pump Optimisation. Condenser Water Primary System—the five pumps of which four were operating over the 24 hour period were modulated against the Condenser Secondary main index water temperature. This has resulted in the BMS providing meaningful control of this system and has seen a load reduction from 120 kW to 90 kW during Mall operating hours and a reduction to approx 30 kW at night. This represents an overall saving of 62.5%.

Chiller Water System and Air Handling Units—these systems have been extensively analysed yielding load reductions as follows—All chiller primary pumps have been modulated against the chiller operation, and as a result, the BMS effectively disables them at night. The chiller is under substantially less strain first thing in the morning with the out-of-hours heat transfer between condenser and chiller water eliminated. With the revised AHU schedules and operational correction, the BMS can turn off the chiller primaries overnight and for substantial parts of the day in non-Summer months. Main Chiller loads have also been substantially reduced following the correction of outside air temperature sensor data. For a very large part of the year, outside fresh air is highly useful as a primary coolant for buildings in Ireland without the need for forced cooling.

The reduction in electrical load following these interventions will yield approximately 130 kW.

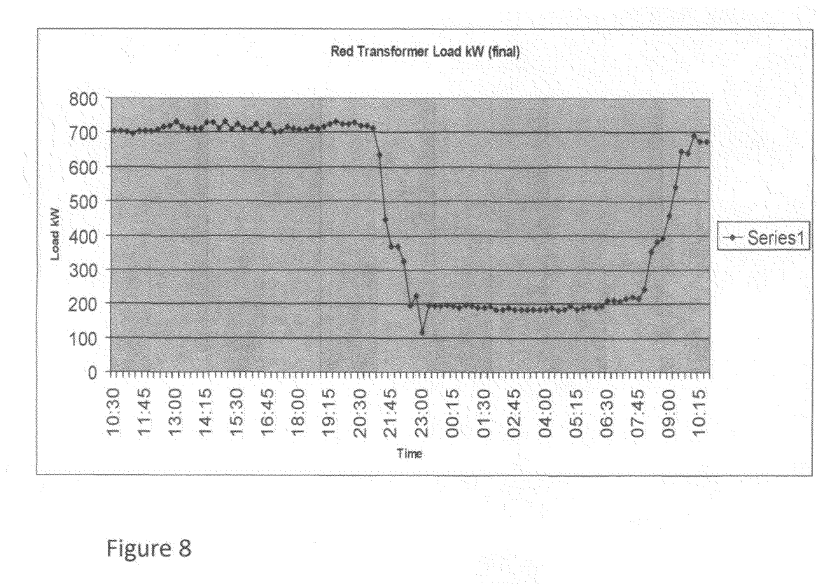

FIG. 8 shows the Red Transformer load as it is after the chiller pumps have been included along with two of the primary condenser pumps. The base load at night has reduced from 400 to under 190 kW. It is expected that a further 30 kW will be shed at night when the third Primary condenser water pump goes offline. The double drop to 100 kW represents the two hours during which all pumps in the pump room are switched off to allow the system to settle, vent and refill to remove excess aeration (currently at 10.30pm and 6.30am).

Lighting Systems—this load reduction is likely to be a significant contributor to the overall number but is more complex and can be more expensive to implement. Lighting is not only a direct primary energy user but is also a very effective heat source. Less lighting not only saves primary energy but also reduces the cooling load for any commercial building. Lighting systems account for over 450 kW of electrical baseload and while we can eliminate a substantial part of this baseload at night, we can also significantly reduce the day-time lighting load by better control of lighting circuits by the BMS and modulating the control with a Lux sensor. When outside light levels are reading full sunshine, the internal lighting is unnoticeable and therefore a substantial part of the lighting load can be eliminated. Savings numbers on the overall lighting systems amount to 31.5% (or approx 140 kW).

As can be appreciated by the foregoing, the invention solves the problem of re-engineering completed buildings. Buildings are commissioned once completed by ensuring entire installed plant is capable of working to design parameters and that the plant is controllable as intended by the Building Service engineers—in other words, as designed. The commissioning process does not take the occupant into account nor the use of the building. The only parameters used to validate the systems are the design parameters. The invention taught herein ignores these design parameters but utilizes data from two other sources—actual building measurements and occupant use of the building. This data can be readily collected from the building over a relatively short space of time. This data enables the present invention to formulate the optimum use of plant within the building where two drivers—occupant comfort and energy use—are foremost.

1. A method for optimizing energy use of a building of interest, said method comprising the steps of:
determining the “building characterization” of said building of interest with the minimum amount of parametric data, where the step of determining said “building characterization” includes the sub steps of:
a. determining how said building of interest responds to current use by current occupants;
b. determining how said building of interest responds to external weather conditions;
c. determining how actual installed plant used to heat/cool and ventilate said building of interest interacts with said building of interest;
determining how the running times of said actual installed plant affect occupant comfort levels during one or more predetermined time periods,
using said building characterization to model energy usage of said building of interest, so that for any time period of interest, said building of interest may be optimized with respect to the energy consumption of said building of interest.

2. The method as in claim 1 wherein the step of determining the building characterization of said building of interest further includes the step of deploying a sensor array, (where said building of interest does not already have such a sensor array) such that said sensor array transmits data useful in the building characterization.

3. The method as in claim 2 wherein the step of deploying a sensor array further includes the sub step of analyzing layout of said building of interest to determine how best to deploy said sensor array.

4. The method as in claim 3 wherein said step of deploying a sensor array further includes deploying a sensor array of fewer then 12 sensors.

5. The method of claim 1 further including additional steps of:
performing the sub steps of Usage/Energy Use mapping and Data Collection.

6. The method of claim 5, further including additional steps of:
performing the sub steps of Occupant Comfort Analysis.

7. The method of claim 6, further including additional steps of:
performing the sub steps of load matching/Plant Scheduling.

8. The method of claim 7, further including additional steps of:
performing the sub steps of Occupant Comfort Data Collection and Building Characterization.

9. The method of claim 8, further including additional steps of:
performing the sub steps of designing iterative building energy strategies.

10. The method of claim 9, further including additional steps of:
performing the sub steps of Energy usage and savings report generation, generating audit reports and detailed advice reports.

11. The method as in claim 10, further including the step of adjusting said building characterization and/or said energy model of said building of interest in response to changes in use, personnel, weather, or actual plant of said building of interest.

12. The method as in claim 11, wherein said steps are repeated iteratively, enabling continuous optimization of energy use of said building of interest.

13. The method as in claim 10, further including the step of assigning an energy equation to said building of interest, where said energy equation describes a model of how said building of interest uses energy.

14. A method of collecting data pertaining to a building of interest, such that said data enables design of an energy model of said building of interest, and said energy model enables continuous optimization of said energy consumption of said building of interest.

15. A method of continuous optimization of energy usage of a building of interest, said method providing means whereby the step of collecting a limited dataset provides a sufficient characterization of said building of interest thereby enabling design of iterative building energy strategies, such that an action plan whereby energy use of said building of interest may be minimized may be implemented.
